(19) United States
(12) Patent Application Publication
(10) Pub. No.: US 2026/0331941 A1
(43) Pub. Date: Oct. 22, 2026

(54) SYSTEMS AND METHODS FOR BATTERY MANAGEMENT

(71) Applicant: Caterpillar Inc., Peoria, IL (US)

(72) Inventors: Souvik Das, Bangalore (IN); L S N V A Vinaykumar Gullapudi, Koyyalagudem (IN); Malay Bhunia, Paschim Medinipur (IN); Umesh B S, Tumakuru (IN); Karthikeyan Kottaisamy, Ramanathapuram (IN); Aravinth Manivannan, Bengaluru (IN)

(73) Assignee: Caterpillar Inc., Peoria, IL (US)

(21) Appl. No.: 19/184,785

(22) Filed: Apr. 21, 2025

(51) Int. Cl. H02J 7/00

(52) U.S. Cl. CPC H02J 7/96; H02J 2207/20

(57) ABSTRACT

At least one aspect of the disclosure is directed to systems and methods for charging batteries. A system can include an alternating current (AC)-to-direct current (DC) converter, electrically coupled to a power source, the AC-to-DC converter configured to convert supplied power from the power source and provide converted power to one or more first output terminals. The system can include a DC-to-DC converter electrically coupled via one or more input terminals, to the one or more first output terminals, the DC-to-DC converter configured to be electrically coupled to the battery via one or more second output terminals. The system can include one or more first contactors, connected between the one or more first output terminals and the one or more second output terminals. The system can include one or more second contactors, connected between the one or more first output terminals and the one or more input terminals.

### TECHNICAL FIELD

The present implementations relate generally to the field of batteries, and more particularly systems and methods for charging batteries.

### BACKGROUND

Battery managers can charge battery packs at target voltage ranges but may not be configured to charge batteries that are outside these target voltage ranges. For example, battery managers can charge batteries at low voltages (e.g., 400V) or high voltages (e.g., 1400V) but may not be configured for simultaneously charging batteries at high and low voltages. Further, some battery managers can produce instabilities. For example, battery managers that include an alternating current (AC)-to-direct current (DC) converter in combination with a bidirectional DC-to-DC converter, may produce instabilities at higher battery voltages (e.g., 1400V). Further, battery managers can produce power losses. For example, battery managers may produce power losses because of conduction losses, switching losses, and losses corresponding to passive components.

For example, U.S. Patent Application Publication No. 2024/0097459 describes an electrical circuit for a vehicle high-voltage network, the network including two electrical stores. One aspect of U.S. Patent Application Publication No. 2024/0097459 describes: a first switching unit electrically connected to a first pole connector and the first connection point, where the first pole connector is electrically connected to the first pole of the first battery; and a second switching unit electrically connected to a second pole connector and the second connection point, where the second pole connector is electrically connected to the second pole of the second battery. Further, the first switching unit and the second switching unit can be switched between an electrically separating and an electrically connecting state.

### SUMMARY

A first aspect provided herein relates to a system for charging a battery. The system can include an alternating current (AC)-to-direct current (DC) converter electrically coupled to a power source. The AC-to-DC converter can be configured to convert supplied power from the power source and provide converted power to one or more first output terminals. The system can further include a DC-to-DC converter electrically coupled via corresponding one or more input terminals to the one or more first output terminals. The DC-to-DC converter can be configured to be electrically coupled to a battery via one or more second output terminals. The system can further include one or more first contactors connected between the one or more first output terminals and the one or more second output terminals. The system can further include one or more second contactors connected between the one or more first output terminals and the one or more input terminals.

A second aspect provided herein relates to a method of charging a battery. The method can include determining, by one or more controllers electrically coupled to the battery, one or more metrics relating to a battery rating of the battery via a circuit controlled by the one or more controllers. The circuit can include an alternating current (AC)-to-direct current (DC) converter, a DC-to-DC converter, one or more first contactors forming a bypass path from the AC-to-DC converter to the battery, and one or more second contactors forming a conduction path from the AC-to-DC converter to the DC-to-DC converter. The method can further include transmitting, by the one or more controllers one or more first signals to the one or more first contactors and the one or more second contactors, to cause the one or more first contactors to be in an open state and the one or more second contactors to be in a closed state responsive to the battery voltage of the battery being less than, or less than or equal to, a threshold voltage. The method can further include transmitting, by the one or more controllers, one or more second signals to the one or more first contactors and the one or more second contactors, to cause the one or more first contactors to be in the closed state and the one or more second contactors to be in the open state responsive to the battery voltage of the battery being greater than, or less than or equal to, the threshold voltage.

A third aspect provided herein relates to a battery manager. The battery manager can include an alternating current (AC)-to-direct current (DC) converter, electrically coupled to a power source. The AC-to-DC converter can be configured to convert supplied power from the power source and provide converted power to one or more first output terminals. The battery manager can further include a DC-to-DC converter electrically coupled via one or more input terminals, to the one or more first output terminals. The DC-to-DC converter can be configured to be electrically coupled to a battery via one or more second output terminals. The battery manager can further include one or more first contactors connected between the one or more first output terminals and the one or more second output terminals. The battery manager can further include one or more second contactors connected between the one or more first output terminals and the one or more input terminals. The battery manager can further include one or more controllers electrically coupled to the one or more first contactors, and the one or more second contactors. The controller can control the one or more first contactors to be in an open state, and the one or more second contactors to be in a closed state, responsive to a battery voltage of the battery being less than, or less than or equal to, a threshold voltage. The controller can also control the one or more first contactors to be in the closed state, and the one or more second contactors to be in the open state, responsive to the battery voltage of the battery being greater than, or greater than or equal to, the threshold voltage.

### BRIEF DESCRIPTION OF THE DRAWINGS

These and other aspects and features of the present implementations will become apparent to those ordinarily skilled in the art upon review of the following description of specific implementations in conjunction with the accompanying figures.

FIG. 1 is a block diagram of a charging scenario, in accordance with present implementations.

FIG. 2 is an exploded diagram showing the components of the charging scenario of FIG. 1, in accordance with present implementations.

FIG. 3 is a block diagram of a charging scenario showing a first contactor open and a second contactor open, in accordance with present implementations.

FIG. 4 is a block diagram of a charging scenario showing a first contactor open and a second contactor closed, in accordance with present implementations.

FIG. 5 is a block diagram of a battery management showing a first contactor closed and a second contactor open, in accordance with present implementations.

FIG. 6 is a flow chart of a method for charging a battery, in accordance with present implementations.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the FIGURES, the systems and methods described herein may be configured, designed, or otherwise arranged to implement one or more charging systems configured to charge one or more batteries. The systems and methods described herein can charge batteries corresponding to one or more voltages, reduce electrical instabilities at high battery output voltages, and reduce power losses. According to the systems and methods described herein, a controller can control one or more first contactors to be in an open state and one or more second contactors to be in a closed state responsive to a battery rating of a battery being less than, or less than or equal to, a threshold voltage. Further, the controller can control the one or more first contactors to be in a closed state and the one or more second contactors to be in an open state responsive to the battery rating of the battery being greater than, or less than or equal to, the threshold voltage.

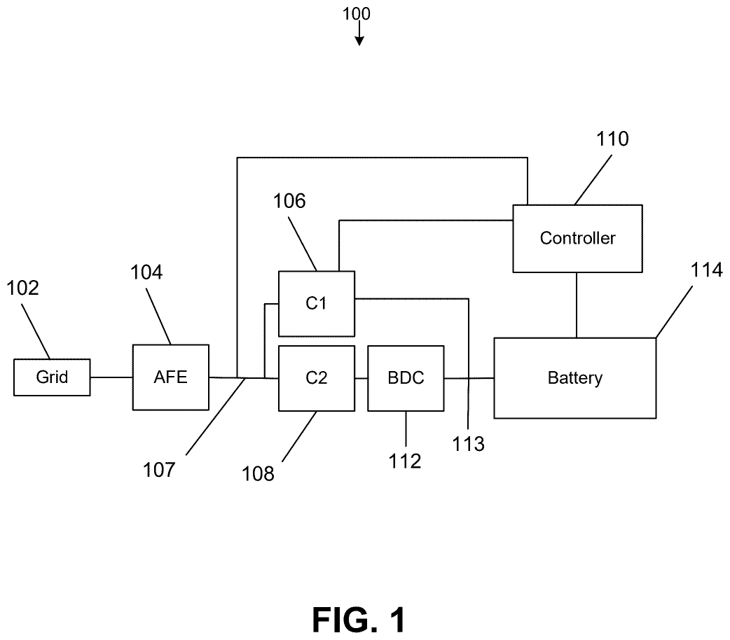

FIG. 1 is a view of a charging system 100. Charging system 100 can include a grid 102, an active front end (AFE) 104, a first contactor 106, a DC link 107, a second contactor 108, a controller 110, a bidirectional converter (BDC) 112, output terminal 113, and a battery 114. Charging system 100 can be configured to facilitate charging or discharging of battery 114, where battery 114 can include one or more batteries of various voltages (e.g., 250V to 1500V). Power can flow from grid 102 to battery 114 during a charging cycle and power can flow from battery 114 to a resistive load (not shown) during a discharge cycle. Further, charging system 100 can include one or more power converters. For example, charging system 100 can include an AFE 104 and a BDC 112 to convert AC power from grid 102 to DC power and/or buck DC power supplied to battery 114. Further, the battery 114 charged by charging system 100 can be an on-board or off-board battery. For example, the battery 114 can be an on-board battery corresponding to a vehicle (e.g., an electric vehicle) and/or an off-board battery corresponding to one or more machines. Additionally, charging system 100 can include and/or support one or more types of charging/discharging. For example, charging system 100 can support DC fast charging.

Charging system 100 can include one or more components to facilitate battery management. In some embodiments, the controller 110 can monitor battery 114. For example, and in some embodiments, controller 110 can include one or more sensors that monitor a state of charge, a state of health, a state of power, and/or a temperature of battery 114. As another example, and in some embodiments, controller 110 can receive one or more signals from the battery 114 (or one or more sensors of the battery 114) indicating the state of the battery (e.g., state of charge, state of health, state of power, and/or temperature of the battery). Controller 110 can initiate one or more actions responsive to, based on, or according to the state of the battery. For example, controller 110 can configure one or more switches corresponding to AFE 104 and/or BDC 112 to reduce a current level. Further, charging system 100 can include one or more components for safe charging. For example, charging system 100 can include one or more voltage regulators to regulate transient currents and/or current regulators to regulate transient currents.

Charging system 100 can include one or more power converters (e.g., AFE 104 and BDC 112). The power converters can include one or more switches. For example, the switches included in AFE 104 and BDC 112 can include insulated gate bipolar transistors (IGBTs) or metal oxide semiconductor field effect transistors (MOSFETs). The switches can also be rated for one or more voltages depending on the topology of charging system 100. For example, the one or more switches can be rated for a voltage that is greater than or equal to half of the battery voltage of battery 114 for a first configuration, or the one or more switches can be rated for a voltage that is greater than or equal to half of the battery voltage of battery 114 for a second configuration. In some aspects, the one or more switches can be configured to form rectifiers.

Charging system 100 can include AFE 104. In some embodiments, AFE 104 can be an AC-to-DC converter 104. AFE 104 can also include one or more AC-to-DC converters configured to rectify AC power to DC power and/or invert DC power to AC power. For example, AFE can rectify AC power of grid 102 to DC power for supplying to the battery 114 and/or BDC 112. AFE 104 can include one or more switch topologies. In one example, AFE 104 can include a three-level AFE (3L-AFE). The 3L-AFE can include three voltage steps, such as +V/2 volts, zero volts, and −V/2 volts, where the V is the DC link voltage of the 3L-AFE. Further, the 3L-AFE can include a neutral point clamp topology, a T-type topology, a flying capacitor topology, or any other topology for AC-to-DC battery charging. In another example, AFE 104 can include a two-level AFE (2L-AFE). The 2L-AFE can include two voltage steps, such as +V/2 volts and −V/2 volts, where V is the DC link voltage of the 2L-AFE. Further, the 2L-AFE can include a voltage source converter topology, a current source converter topology, a hard switched topology, a soft switched topology, a matrix converter topology, and any other 2L-AFE topology for AC-to-DC battery charging.

In some aspects, controller 110 can control one or more of the switches corresponding to AFE 104. Controller 110 can control the one or more switches corresponding to AFE 104 (e.g., a 2L-AFE, a 3L-AFE, etc.) to generate smooth output waveforms, where smooth waveforms correspond to a reduced total harmonic distribution (THD). Further, controller 110 can control the one or more switches corresponding to AFE 104 to operate AFE 104 at high switching frequencies. Additionally, AFE 104 can control the one or more switches corresponding to AFE 104 to achieve a near-unity power factor. In some aspects, AFE 104 uses one or more soft switching techniques (e.g., pulse width modulation) to reduce switching losses.

Charging system 100 can include first contactor 106 and second contactor 108. First contactor 106 can be electrically connected to a first terminal and a second terminal. Second contactor 108 can be electrically connected to the first terminal and a BDC input of BDC 112. The first terminal can connect an AFE output of AFE 104, a first contactor input of first contactor 106, and a second contactor input of second contactor 108. In some aspects, DC link 107 can include the first output terminal, where the DC link 107 can connect AFE 104 to BDC 112. Further, the second terminal can include output terminal 113, where output terminal 113 can connect a filtered output of BDC 112 to battery 114. First contactor 106 and second contactor 108 can include electromechanical contactors, solid-state contactors, hybrid contactors, vacuum contactors, or any other contactor for battery charging. Further, first contactor 106 and second contactor 108 can be switches, such as MOSFETs, IGBTs, relays, or any other switch for AC-to-DC battery charging. First contactor 106 and second contactor 108 can be rated for high voltages (e.g., 1500V) and/or the switches can have low resistances (e.g., 100<<ohms). Additionally, controller 110 can control first contactor 106 and second contactor 108. Controller 110 can open and/or close first contactor 106 and second contactor 108 based on an operation mode. The operation mode can correspond to a battery voltage of battery 114 and/or a DC link voltage of DC link 107 (also known as a reference voltage). Controller 110 can also monitor the state of first contactor 106 and second contactor 108. For example, controller 110 can control positional sensors and/or auxiliary contacts that monitor the position of first contactor 106 and second contactor 108. Although FIG. 1 only shows first contactor 106 and second contactor 108, it should be appreciated that the figures can include more contactors than those shown in the figures based on the configuration.

Charging system 100 can include BDC 112. In some embodiments, BDC 112 can be a DC-to-DC converter 112. BDC 112 can also include one or more DC-to-DC converters that buck (e.g., decrease) a DC voltage. For example, BDC 112 can buck a DC output voltage of AFE 104 to match a battery voltage of battery 114. BDC 112 can include one or more switch topologies. In some aspects, BDC 112 can include a 3L-BDC topology. The 3L-BDC can include three voltage steps, such as +V/2 volts, −V/2 volts, and zero volts, where V is the DC link voltage of the 3L-BDC. In some aspects, BDC 112 can include a 2L-BDC topology. The 2L-BDC can include two voltage steps, such as +V volts and zero volts, where V is the DC link voltage of the 2L-BDC. Further, the 2L-BDC can include isolated topologies and non-isolated topologies. Non-isolated topologies can include bidirectional buck-boost converters, interleaved bidirectional buck-boost converter, switched-capacitor or switched-inductor bidirectional buck-boost converters, and any other non-isolated bidirectional converter that is applicable on the context of AC-to-DC battery charging. Isolated topologies can include dual active bridge bidirectional converters, isolated bidirectional flyback converters, isolated bidirectional forward converters, isolated bidirectional CLLC resonant converters, and any other isolated bidirectional converter that is applicable on the context of AC-to-DC battery charging. In some aspects, BDC 112 can support one or more control algorithms, where controller 110 can execute the one or more control algorithms. For example, BDC 112 can support pulse-width modulation control, hysteresis control, proportional-integral-derivative control, resonance control, or any other control algorithm applicable in the context of gird-to-battery charging. In some aspects, BDC 112 can use one or more soft switching techniques, such as zero-voltage switching and zero-current switches to reduce power losses. Further, BDC 112 can discharge power from battery 114 to a resistive load (not shown).

Charging system 100 can include controller 110, where controller 110 can represent one or more controllers for controlling circuitry in charging system 100. Controller 110 can be a programmable electronic control unit configured to interface with one or more components of charging system 100. Controller 110 can include one or more ports to interface with the one or more components of charging system 100, such as gate drive signal ports, relay ports, digital output ports, CAN ports, GPIO ports, and any other port that can allow controller 110 to interface with the one or more components of charging system 100. Controller 110 can include one or more processing circuits, such as microcontrollers, digital signal processors (DSPs), field-programmable gate array (FPGAs), and/or application-specific integrated circuit (ASICs), capable of interpreting one or more computer-readable instructions. Controller 110 can also include one or more memory units, including volatile memory (e.g., RAM), non-volatile memory (e.g., flash memory), electrically erasable programmable read-only memory (EEPROM), read only memory (ROM), static random access memory (SRAM), hard disk drives (HHD), solid-state drives (SSD), and other type of memory used by a controller in the context of AC-to-DC battery charging. The one or more memory units of controller 110 can store instructions and the one or more processing circuits of controller 110 can load the instructions and execute the instructions.

Controller 110 can facilitate the charging and/or discharging of battery 114. Controller 110 can electrically connect with the one or more components of charging system 100. For example, controller 110 can be electrically connected to AFE 104, DC link 107, first contactor 106, second contactor 108, BDC 112, and battery 114. Controller 110 can control and/or monitor one or more components of charging system 100. Controller 110 can execute one or more instructions (e.g., executable code) to monitor the one or more components electrically connected to controller 110. For example, controller 110 can execute one or more instructions to control one or more sensors electrically connected to battery 114 and/or DC link 107, where the one or more sensors (e.g., voltage sensors) can determine a battery voltage of battery 114 and/or a DC link voltage of DC link 107. Controller 110 can also execute one or more instructions to control the one or more components electrically connected to controller 110. For example, controller 110 can execute one or more instructions to generate one or more switching control signals (e.g., pulse-width modulation signals) to control the on/off state of the one or more switches corresponding to AFE 104 and/or BDC 112. The switching control signals may be based on a comparison between one or more controls signals and one or more triangular waveforms. In some aspects, controller 110 can include gate driver circuits to amplify the voltage of the one or more switching signals. In another example, controller 110 can execute one or more instructions to control the state of first contactor 106 and/or second contactor 108, where first contactor 106 and second contactor 108 can be in an open state or a closed state.

In some aspects, charging system 100 can represent/implement one or more charging scenarios. In one example, charging system 100 can represent charging of an on-board battery. Battery 114 can be a battery included in a vehicle (e.g., electric vehicle, construction vehicle, etc.) and grid 102 can include a charging station connected to a power gird. In another example, charging system 100 can represent charging of an off-board battery. Battery 114 can be a battery pack for uninterruptible power supply systems and grid 102 can represent an AC outlet connected to a power grid.

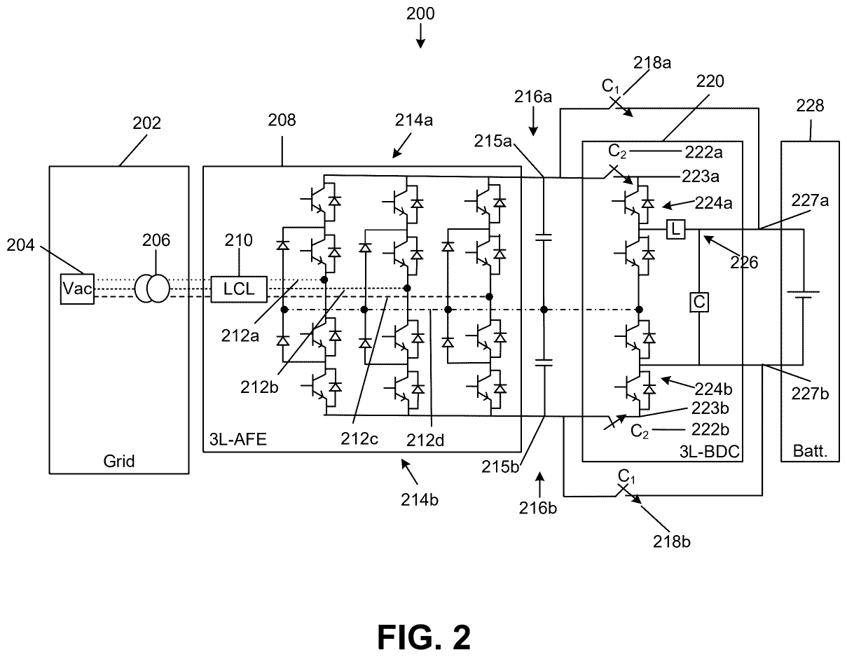

Referring now to FIG. 2, a charging system 200 is shown. Charging system 200 can include grid 202, AFE 208, top first output terminal 215a and bottom first output terminal 215b (referred to hereinafter as “first output terminal 215”), top DC link 216a and bottom DC link 216b (referred to hereinafter as “DC link 216”), top first contactor 218a and bottom first contactor 218b (referred to hereinafter as first contactor 218), BDC 220, and battery 228. Grid 202 can include power source 204 and transformer 206. AFE 208 can include first filter 210, power lines 212a-212d, and top AFE switches 214a and bottom AFE switches 214b (referred to hereinafter as “AFE switches 214”). BDC 220 can include top second contactor 222a and bottom second contactor 222b (referred to hereinafter as “second contactor 222”), top input terminal 223a and bottom input terminal 223b (referred to hereinafter as “input terminal 223”), top BDC switches 224a and bottom BDC switches 224b (referred to hereinafter as “BDC switches 224”), second filter 226, top second output terminal 227a and bottom second output terminal 227b (referred to hereinafter as “second output terminal 227”), and battery 228.

Charging system 200 can include grid 202, where grid 202 can include power source 204 and transformer 206. In some aspects, power source 204 can be an AC power source. For example, power source 204 can provide three-phase AC power to transformer 206 via power lines 212a-212c, where transformer 206 provides a transformed AC power to AFE 208. In some aspects, transformer 206 can include an isolation transformer. For example, transformer 206 can include a transformer designed to electrically isolate the primary and secondary windings of the transformer, so that power can be transferred between the primary and secondary winding via electromagnetic induction. Transformer 206 can include one or more isolated transformer configurations. For example, transformer 206 can include a 1:1 isolation transformer, a step up/step-down isolation transformer, a shielded isolation transformer, a pulse transformer, and any other transformer that is compatible with AC-to-DC battery charging.

Charging system 200 can include AFE 208. In some aspects, AFE 208 can be an AC-to-DC converter 208. AFE 208 can include first filter 210, where first filter 210 can include one or more electrical filters. First filter 210 can include one or more filters configured to reduce current/voltage harmonics of the grid, improve the power factor, reduce electromagnetic interference (EMI), and facilitate electromagnetic compatibility (EMC). For example, first filter 210 can include one or more LCL filters, one or more LC filters, one or more EMI/EMC filters, or one or more of any filters. The output of first filter 210 can connect to one or more AC inputs of AFE 208 via power lines 212a-212c, where each of power lines 212a-212c corresponds to a respective AC power phase. In some aspects, power line 212d is a neutral line connecting AFE 208, DC link 216, and BDC 220. Further, AFE 208 can include AFE switches 214, where AFE switches 214 can form a three-level rectifier bridge configured to convert three-phase AC power to DC power. In some aspects, AFE switches 214 can be first circuitry 214. AFE switches 214 can also include between six and twelve switches to form the three-level rectifier bridge. AFE switches 214 can also include one or more clamping diodes, where the clamping diodes can balance a corresponding switch voltage across each of the AFE switches 214. AFE 208 can support one or more modes of operation. For example, the AFE 208 can operate in a passive rectification mode, where the AFE switches 214 turn off and only the diodes in AFE 208 conduct. As another example, the AFE 208 can operate in an active rectification mode, where the AFE switches 214 actively conduct electrical energy using via pulse width modulation. While not shown in FIG. 2, it should be appreciated that controller 110 can be electrically connected to AFE switches 214, where controller 110 can control AFE switches 214.

Charging system 200 can include DC link 216. DC link 216 can separate AFE 208 from BDC 220. DC link 216 can include first output terminal 215. First output terminal 215 can electrically connect to one or more outputs of AFE 208, first contactor 218, and second contactor 222. Further, DC link 216 can include one or more circuit components. In some aspects, the DC link 216 can include one or more capacitors in series. In one example, the DC link 216 can include two in-series neutral point clamped capacitors, where the voltage across each of the two capacitors is half of the DC link voltage of DC link 216 and the midpoint between the two in-series capacitors is connected to a neutral point (e.g., 0V).

Charging system 200 can include first contactor 218 and second contactor 222. First contactor 218 can selectively open and close to create a path between DC link 216 and second output terminal 227, where second output terminal 227 is connected to second filter 226 and battery 228. Further, first contactor 218 can also open to disconnect DC link 216 from second output terminal 227. Second contactor 222 can close to create a conductive path between DC link 216 and input terminal 223. Second contactor 222 can also open to disconnect the conductive path between DC link 216 and input terminal 223. First contactor 218 and second contactor 222 can remain open at the same time. Generally, however, first contactor 218 and second contactor 222 should not be closed at the same time. While not shown in FIG. 2, it should be appreciated that controller 110 can connect to first contactor 218 and second contactor 222, where controller 110 can control first contactor 218 and second contactor 222.

Charging system 200 can include BDC 220. In some aspects, BDC 220 can be a DC-to-DC converter 220. BDC 220 can include second filter 226, where second filter 226 can include one or more electrical filters. Second filter 226 can include one or more filters configured to reduce voltage/current ripple, suppress EMI, and reduce power losses. For example, second filter 226 can include one or more LC filters, one or more LCL filters, one or more RC snubber filters, one or more EMI filters, or one or more of any filters configured to connect to DC outputs of BDC 220. Further, BDC 220 can include BDC switches 224. In some aspects, BDC switches 224 can be second circuitry 224. BDC switches 224 can also include at least four switches to control the output voltage level. BDC switches 224 can support one or more modes of operation. Some modes of operation are generic. For example, BDC 220 can operate in a buck mode, where BDC switches 224 are configured to decrease a DC input voltage. Other modes of operation include specific components. For example, BDC switches 224 can operate in continuous conduction mode (e.g., inductor current never reaches zero during the switching cycle), discontinuous conduction mode (e.g., the inductor current drops to zero before the next switching cycle), and/or interleave mode (e.g., phase-shifted switching). Further, BDC switches 224 can support hard switching and soft switching (e.g., zero voltage switching, zero current switching, etc.).

In some aspects, AFE 208, DC link 216, first contactor 218, BDC 220, second contactor 222, and controller 110 form a battery manager. The battery manager can be housed in a housing. The housing can protect the electrical components included in the battery manager. Further, the housing can be configured to withstand high vibration, seismic events, and shock loading. The housing can include an input port configured to receive AC power. For example, the input port can receive a power cable, where the power cable can connect to an AC power outlet. The housing can also include an output port configured to provide DC power. For example, the output port can receive a power cable, where the power cable can connect to a battery. Further, the housing can include one or more built-in systems and/or components to improve the operation of the battery manager. For example, the housing can include an air-conditioning system, a dehumidification system, a radiator, one or more fans, or any other built-in components that could improve the operation of the battery manager.

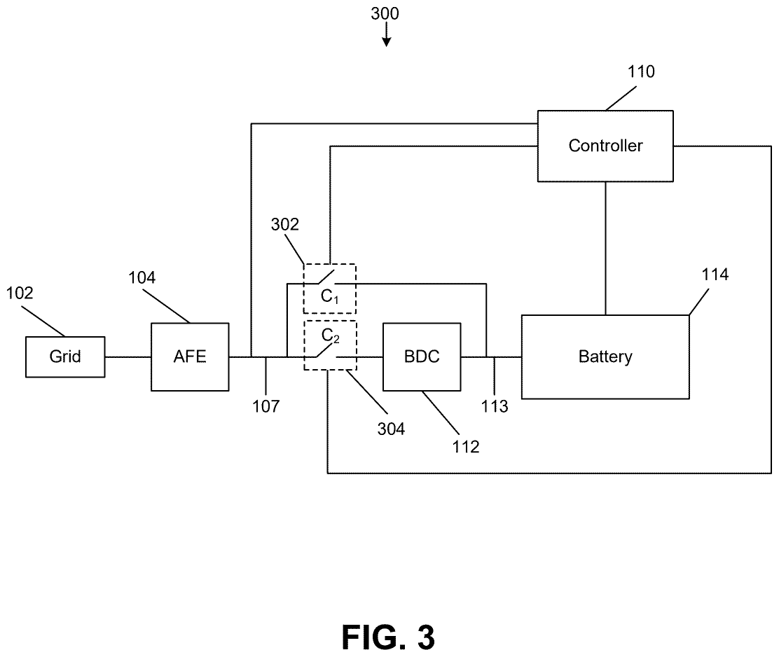

Referring now to FIG. 3-FIG. 5, depicted are charging scenarios 300-500 relating to the charging system 100 described above with reference to FIG. 1-FIG. 2, according to the determined voltage of the battery 114, according to example implementations of the present disclosure. The charging scenarios 300-500 may include grid 102, AFE 104, BDC 112, controller 110, output terminal 113, battery 114, and various states (e.g., open state, closed state, etc.) of first contactor 106 and second contactor 108. Beginning with charging scenario 300, the charging scenario 300 shown in FIG. 3 may be implemented for configuring a setup mode.

In charging scenario 300, controller 110 can cause first contactor 106 and second contactor 108 to open. Controller 110 can transmit one or more open control signals to first contactor 106 and second contactor 108, where first contactor 106 and second contactor 108 open responsive to receiving the open signals from controller 110. In some aspects, opening first contactor 106 and second contactor 108 can include discharging a coil corresponding to each of first contactor 106 and second contactor 108. For example, the one or more control signals can cause the coil corresponding to each of first contactor 106 and second contactor 108 to deenergize. In another example, the one or more control signals can cause create a discharge path for the coil corresponding to each of first contactor 106 and second contactor 108.

In charging scenario 300, controller 110 can determine voltage for one or more of the components in charging scenario 300. Controller 110 can determine the battery voltage of battery 114. Controller 110 can determine the battery voltage of battery 114 responsive to controller 110 causing first contactor 106 and second contactor 108 to open. In some aspects, controller 110 can send one or more signals to one or more sensors and/or voltage circuits connected to battery 114 to determine the battery voltage of battery 114. Controller can also determine a reference voltage based on the battery voltage, where the reference voltage can be a DC link voltage of DC link 107. For example, the reference voltage can be the same as the battery voltage of battery 114 when controller 110 determines that the battery voltage of battery 114 is in a high voltage range (e.g., between 800V and 1500V). In another example, the reference voltage can be 1000V when controller 110 determines that the reference voltage is in a low voltage range (e.g., between 250V and 800V). In some aspects, the reference voltage can be a fixed voltage.

In charging scenario 300, controller 110 can control AFE 104 to generate the reference voltage at DC link 107. AFE 104 can generate the reference voltage at DC link 107 responsive to having open first contactor 302 and open second contactor 304, closing a breaker switch controlling the connection between grid 102 and AFE 104, determining a battery voltage of battery 114, and determining a reference voltage. Controller 110 can generate the reference voltage at DC link 107 by controlling (e.g. switching on/off) one or more switches corresponding to AFE 104 (e.g., AFE switches 214). In some aspects, controller 110 can use a feedback mechanism to generate the reference voltage at DC link 107. Controller 110 can measure the DC link voltage of DC link 107 and use a comparator to compare the reference voltage to an actual voltage at DC link 107. Controller 110 can include a control system (e.g., a PID controller) to process the differences between the reference voltage and the actual voltage and adjust the one or more switches corresponding to AFE 104. In some aspects, controller 110 can modify the switching frequency of the one or more switches corresponding to AFE 104. For example, controller 110 can generate a PWM signal for the one or more switches corresponding to AFE 104 and adjust the duty cycle of the PWM signal to generate the reference voltage. Further, one or more processors of controller 110 can execute an algorithm (e.g., support space vector modulation (SVM)) to control the PWM signal.

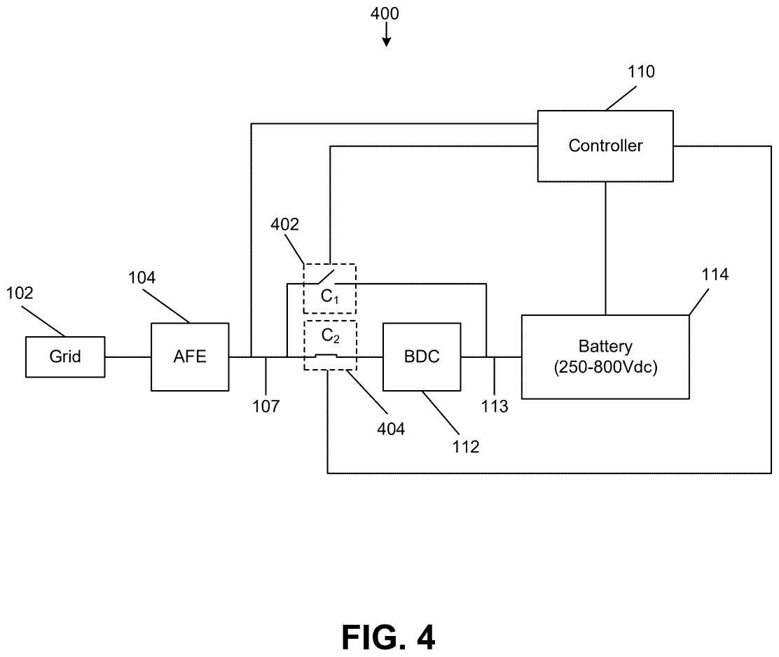

Referring now to FIG. 4, a charging scenario 400 is shown. Charging scenario 400 may include or correspond to a configuration relating to a first operation mode corresponding to a low battery voltage (e.g., between 250V and 800V) of battery 114. In some aspects, charging scenario 400 can begin responsive to charging scenario 300 completing. For example, charging scenario 400 can begin responsive to controller 110 determining a battery voltage of battery 114 and controller 110 configuring the one or more switches of AFE 104 to generate a reference voltage based on the battery voltage of battery 114.

Charging scenario 400 can depend on one or more determinations made by controller 110 in charging scenario 300. In charging scenario 400, controller 110 can previously detect a low battery voltage at battery 114 in charging scenario 300. For example, controller 110 may have determined that battery 114 has a voltage between 250V and 800V. Further, controller 110 can previously determine a reference voltage based on the battery voltage of battery 114 and/or BDC 112, where BDC 112 can be configured to buck the input voltage (e.g., the reference voltage). For example, controller 110 can determine that the reference voltage is 1000V because BDC 112 can buck the reference voltage to generate an output voltage that matches the battery voltage at battery 114 when the refence voltage is 1000V. In some aspects, determining the reference voltage includes controller 110 receiving information from BDC 112. In one example, controller 110 can electrically communicate with one or more processors corresponding to BDC 112 to determine an input voltage/current/power range, an output voltage/current/power range, a duty cycle limit, converter efficiency, and any other parameters relevant to the operational capabilities of BDC 112. In another example, controller 110 can receive data (e.g., operational parameters) from one or more sensors connected to BDC 112 (e.g., sensors connected to the input and output of BDC 112). Accordingly, controller 110 can correctly determine the reference voltage because controller 110 knows that BDC 112 can buck the reference voltage to generate an output voltage that matches the battery voltage of battery 114.

In charging scenario 400, controller 110 can control first contactor 106 and second contactor 108 responsive to the DC link voltage at DC link 107. Controller 110 can cause second contactor 108 to close and cause first contactor 106 to remain open responsive to controller 110 determining that the DC link voltage at DC link 107 to match the reference voltage (e.g., 1000V). With closed second contactor 404, closed second contactor 404 creates a conduction path between DC link 107 and the one or more DC inputs of BDC 112. Further, with open first contactor 402, open first contactor 402 disconnects a conduction path between DC link 107 and output terminal 113. Controller 110 can configure, responsive to power flowing from DC link 107 to the DC inputs of BDC 112 via closed second contactor 404, the switches of BDC 112 to buck the DC input voltage of BDC 112, where the DC input voltage matches the reference voltage, to match the battery voltage of battery 114. Second filter 226 can filter, responsive to BDC 112 generating a DC output voltage, the DC output voltage of BDC 112 to generate a filtered output voltage corresponding to battery 114.

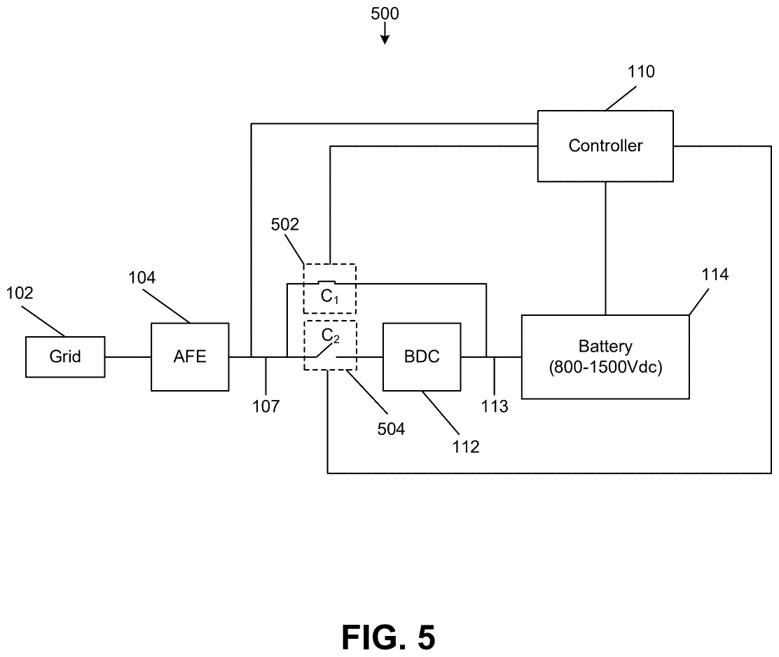

Referring now to FIG. 5, a charging scenario 500 is shown. Charging scenario 500 can include or correspond to a configuration relating to a second operation mode corresponding to a high battery voltage (e.g., between 800V and 1500V) of battery 114. In some aspects, charging scenario 500 can begin responsive to charging scenario 300 completing. For example, charging scenario 500 can begin responsive to controller 110 determining a battery voltage of battery 114 and controller 110 configuring the one or more switches of AFE 104 to generate a reference voltage based on the battery voltage of battery 114.

Charging scenario 500 can depend on one or more determinations made by controller 110 in charging scenario 300. In charging scenario 500, controller 110 can previously detect a high battery voltage at battery 114 in charging scenario 300. For example, controller 110 may have determined that battery 114 has a voltage between 800V and 1500V. Further, controller 110 can previously determine a reference voltage based on the battery voltage of battery 114. For example, controller 110 can determine that the reference voltage is the same as battery voltage of battery 114.

In charging scenario 500, controller 110 can control first contactor 106 and second contactor 108 responsive to the DC link voltage at DC link 107. Controller 110 can cause first contactor 106 to close and cause second contactor 108 to remain open responsive to controller 110 determining that the DC link voltage at DC link 107 to match the reference voltage (e.g., 1400V). With closed first contactor 502, closed first contactor 502 creates a conduction path between DC link 107 and output terminal 113. Further, with open second contactor 504, open second contactor 504 disconnects a conduction path between DC link 107 and one or more DC inputs of BDC 112. With closed first contactor 502 and open second contactor 504, closed first contactor 502 can create a bypass path from DC link 107 to the output terminal connected to second filter 226 and battery 114, where the bypass path allows the DC link voltage at DC link 107 to circumvent BDC 112 and second filter 226.

### INDUSTRIAL APPLICABILITY

The disclosed embodiments may be applicable to any electrical system that relies on AC-to-DC charging. For example, the disclosed embodiments may be applicable to or applied to heavy machinery, such as motorized construction vehicles, motorized construction equipment, drilling machines, drilling equipment, renewable energy solutions, powerplants, manufacturing systems or any other system that can rely on AC-to-DC charging. The disclosed embodiments may be applicable to charge batteries with a range of voltages (e.g., between 250V and 1500V). The disclosed battery manager can charge low voltage and high voltage batteries by controlling when a DC-to-DC converter bucks an output voltage of an AC-to-DC converter. For example, controller 110 can close first contactor 106 and open second contactor 108 to create a conduction path between DC link 107 and output terminal 113 and controller 110 can also open first contactor 106 and close second contactor 108 to create a conduction path between DC link 107 one or more DC inputs of BDC 112. First contactor 106 and second contactor 108 can allow the charging system that includes AFE 104 and BDC 112 to charge battery 114 when battery corresponds to low and high battery voltages, reduce electrical instabilities at high battery output voltages, and reduce power losses.

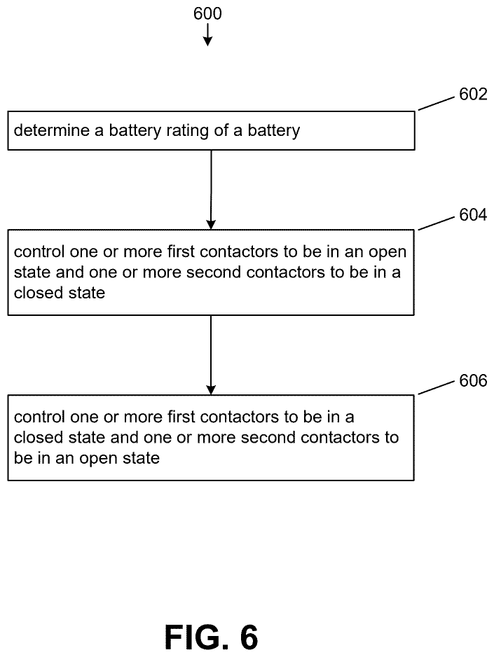

Referring now to FIG. 6, a block diagram of a method for charging a battery is shown. Method 600 can include determining, by one or more controllers electrically coupled to a battery, a battery rating of the battery at block 602, transmitting, by the one or more controllers, one or more first signals to the one or more first contactors and the one or more second contactors at block 604, and transmitting, by the one or more controllers, one or more second signals to the one or more first contactors and the one or more second contactors at block 606.

At block 602, method 600 can include determining, by one or more controllers (e.g., controller 110) electrically coupled to a battery (e.g., battery 114), a battery rating of the battery. The circuit can include an alternating current (AC)-to-direct current (DC) converter (e.g., AFE 104). The circuit can further include a DC-to-DC converter (e.g., BDC 112). In some aspects, the DC-to-DC converter can buck an output voltage of the AC-to-DC converter. Further, one or more first contactors can form a bypass path from the AC-to-DC converter to the battery and one or more second contactors can form a conduction path from the AC-to-DC converter to the DC-to-DC converter.

At block 604, method 600 can include transmitting, by the one or more controllers (e.g., controller 110), one or more first signals to the one or more first contactors (e.g., first contactor 106) and the one or more second contactors (e.g., second contactor 108). The one or more first signals can cause the one or more first contactors to be in an open state and the one or more second contactors to be in a closed state responsive to the battery voltage of the battery (e.g., battery 114) being less than, or less than or equal to, a threshold voltage. The one or more controllers can determine the threshold voltage based on the battery voltage.

At block 606, method 600 can include transmitting, by the one or more controllers (e.g., controller 110), one or more second signals to the one or more first contactors (e.g., first contactor 106) and the one or more second contactors (e.g., second contactor 108). The one or more second signals can cause the one or more first contactors to be in the closed state and the one or more second contactors to be in the open state responsive to the battery voltage of the battery being greater than, or less than or equal to, the threshold voltage. The one or more controllers can determine the threshold voltage based on the battery voltage.

By using the systems and methods described herein, the battery manager (e.g., the combination of AFE 104, DC link 107, BDC 112, first contactor 106, second contactor 108, and controller 110) can improve AC-to-DC battery charging. First, the battery manager can charge one or more batteries with a range of voltages (e.g., between 250V and 1500V), where the one or more batteries correspond to one or more applications (e.g., powering a vehicle, powering equipment, powering data centers, etc.). Second, the battery manager can reduce voltage instabilities that occur in high voltage charging scenarios by closing first contactor 106 and opening second contactor 108 to circumvent BDC 112 in the battery manager. Third, the battery manager can reduce power losses that occur during the battery charging process, which results in a more efficient charging system. Overall, the systems and methods described herein improve AC-to-DC battery charging.

What is claimed is:

1. A system for charging a battery, comprising:
an alternating current (AC)-to-direct current (DC) converter, electrically coupled to a power source, the AC-to-DC converter configured to convert supplied power from the power source and provide converted power to one or more first output terminals;
a DC-to-DC converter electrically coupled via one or more input terminals, to the one or more first output terminals, the DC-to-DC converter configured to be electrically coupled to the battery via one or more second output terminals;
one or more first contactors, connected between the one or more first output terminals and the one or more second output terminals; and
one or more second contactors, connected between the one or more first output terminals and the one or more input terminals.

2. The system of claim 1, further comprising:
one or more controllers electrically coupled to the one or more first contactors, and the one or more second contactors, wherein the one or more controllers are configured to:
control the one or more first contactors to be in an open state, and the one or more second contactors to be in a closed state, responsive to a battery voltage of the battery being less than, or less than or equal to, a threshold voltage; and
control the one or more first contactors to be in the closed state, and the one or more second contactors to be in the open state, responsive to the battery voltage of the battery being greater than, or greater than or equal to, the threshold voltage.

3. The system of claim 2, wherein the one or more controllers are further configured to:
determine the battery voltage of the battery, based on at least one of a signal from the battery or data from a sensor configured to sense the battery voltage; and
control the one or more first contactors and the one or more second contactors, according to the determined battery voltage.

4. The system of claim 2, wherein the one or more controllers are further electrically coupled to first circuitry of the AC-to-DC converter, wherein the one or more controllers are further configured to:
control the one or more first contactors and the one or more second contactors to be in the open state, responsive to an initial connection of the battery to the one or more second output terminals;
determine the battery voltage of the battery;
determine, according to the determined battery voltage, a threshold in which to compare a control signal for the AC-to-DC converter for conversion,
control the first circuitry of the AC-to-DC converter, according to the threshold and the control signal, to produce DC power at a voltage corresponding to the threshold; and
responsive to the AC-to-DC converter producing power at the voltage, control the one or more first contactors and the one or more second contactors to be in the open state or the closed state according to the battery voltage of the battery.

5. The system of claim 4, wherein the threshold is determined to be a fixed threshold, responsive to the battery voltage being less than, or less than or equal to, the threshold voltage, to produce DC power at a fixed voltage.

6. The system of claim 5, wherein the one or more controllers are further electrically coupled to second circuitry of the DC-to-DC converter, the one or more controllers further configured to:
control the second circuitry of the DC-to-DC converter, to reduce the fixed voltage from the AC-to-DC converter, according to the battery voltage of the battery.

7. The system of claim 4, wherein the one or more controllers are further configured to:
select, responsive to the battery voltage being greater than, or greater than or equal to, the threshold voltage, the threshold for comparing to the control signal, according to the battery voltage,
wherein controlling the first circuitry of the AC-to-DC converter produces DC power at the voltage which corresponds to the battery voltage.

8. The system of claim 1, further comprising a transformer electrically coupled between the power source and the AC-to-DC converter, and a first filter between the transformer and the AC-to-DC converter.

9. The system of claim 1, wherein the DC-to-DC converter further comprises a second filter between a plurality of transistors of the DC-to-DC converter and the one or more second output terminals.

10. The system of claim 1, wherein the one or more first contactors and the one or more second contactors are selectively controlled, to selectively provide power from the AC-to-DC converter to the battery, by way of a first path via the one or more first contactors to the battery, or by way of a second path via the one or more second contactors through the DC-to-DC converter to the battery.

11. A method of charging a battery, comprising:
determining, by one or more controllers electrically coupled to the battery, a battery voltage of the battery via a circuit controlled by the one or more controllers, the circuit including an alternating current (AC)-to-direct current (DC) converter, a DC-to-DC converter, one or more first contactors forming a bypass path from the AC-to-DC converter to the battery, and one or more second contactors forming a conduction path from the AC-to-DC converter to the DC-to-DC converter;
transmitting, by the one or more controllers, one or more first signals to the one or more first contactors and the one or more second contactors, to cause the one or more first contactors to be in an open state and the one or more second contactors to be in a closed state responsive to the battery voltage of the battery being less than, or less than or equal to, a threshold voltage; and
transmitting, by the one or more controllers, one or more second signals to the one or more first contactors and the one or more second contactors, to cause the one or more first contactors to be in the closed state and the one or more second contactors to be in the open state responsive to the battery voltage of the battery being greater than, or less than or equal to, the threshold voltage.

12. The method of claim 11, further comprising:
determining, by the one or more controllers, the battery voltage of the battery, based on at least one of a signal from the battery or data from a sensor configured to sense the battery voltage; and
controlling, by the one or more controllers, the one or more first contactors and the one or more second contactors, according to the determined battery voltage.

13. The method of claim 11, further comprising:
transmitting, by the one or more controllers, one or more third signals to the one or more first contactors and the one or more second contactors, to cause the one or more first contactors and the one or more second contactors to be in the open state, responsive to an initial connection of the battery to one or more output terminals;
determining, by the one or more controllers, the battery voltage of the battery;
determining, by the one or more controllers and the determined battery voltage, a threshold in which to compare a control signal for the AC-to-DC converter for conversion,
transmitting, by the one or more controllers, one or more fourth signals to first circuitry of the AC-to-DC converter, according to the threshold and the control signal, to cause the AC-to-DC converter to produce DC power at a voltage corresponding to the threshold; and
responsive to the AC-to-DC converter producing power at the voltage, controlling, by the controller, the one or more first contactors and the one or more second contactors to be in the open state or the closed state according to the battery voltage of the battery.

14. The method of claim 13, wherein the threshold is determined to be a fixed threshold, responsive to the battery voltage being less than, or less than or equal to, the threshold voltage, to produce DC power at a fixed voltage.

15. The method of claim 14, further comprising:
transmitting, by the one or more controllers, one or more fifth signals to second circuitry of the DC-to-DC converter, to reduce the fixed voltage from the AC-to-DC converter, according to the battery voltage of the battery.

16. The method of claim 13, further comprising:
selecting, by the one or more controllers, responsive to the battery voltage being greater than, or greater than or equal to, the threshold voltage, the threshold for comparing to the control signal, according to the battery voltage,
the one or more fourth signals cause the AC-to-DC converter produces DC power at the voltage which corresponds to the battery voltage.

17. A battery manager, comprising:
an alternating current (AC)-to-direct current (DC) converter, electrically coupled to a power source, the AC-to-DC converter configured to convert supplied power from the power source and provide converted power to one or more first output terminals;
a DC-to-DC converter electrically coupled via one or more input terminals, to the one or more first output terminals, the DC-to-DC converter configured to be electrically coupled to a battery via one or more second output terminals;
one or more first contactors, connected between the one or more first output terminals and the one or more second output terminals;
one or more second contactors, connected between the one or more first output terminals and the one or more input terminals; and
one or more controllers electrically coupled to the one or more first contactors, and the one or more second contactors, wherein the one or more controllers are configured to:
control the one or more first contactors to be in an open state, and the one or more second contactors to be in a closed state, responsive to a battery voltage of the battery being less than, or less than or equal to, a threshold voltage; and
control the one or more first contactors to be in the closed state, and the one or more second contactors to be in the open state, responsive to the battery voltage of the battery being greater than, or greater than or equal to, the threshold voltage.

18. The battery manager of claim 17, wherein the one or more controllers are configured to:
control the one or more first contactors and the one or more second contactors to be in the open state, responsive to an initial connection of the battery to the one or more second output terminals;
determine the battery voltage of the battery;
determine, according to the determined battery voltage, a threshold in which to compare a control signal for the AC-to-DC converter for conversion,
control a first circuitry of the AC-to-DC converter, according to the threshold and the control signal, to produce DC power at a voltage corresponding to the threshold; and
responsive to the AC-to-DC converter producing power at the voltage, control the one or more first contactors and the one or more second contactors to be in the open state or the closed state according to the battery voltage of the battery.

19. The battery manager of claim 18, wherein the threshold is determined to be a fixed threshold, responsive to the battery voltage being less than, or less than or equal to, the threshold voltage, to produce DC power at a fixed voltage, and wherein the one or more controllers are further electrically coupled to second circuitry of the DC-to-DC converter, the controller further configured to:
control the second circuitry of the DC-to-DC converter, to reduce the fixed voltage from the AC-to-DC converter, according to the battery voltage of the battery.

20. The battery manager of claim 18, wherein the one or more controllers are further configured to:
select, responsive to the battery voltage being greater than, or greater than or equal to, the threshold voltage, the threshold for comparing to the control signal, according to the battery voltage,
wherein controlling the first circuitry of the AC-to-DC converter produces DC power at the voltage which corresponds to the battery voltage.
